(19) United States
(12) Patent Application Publication
(10) Pub. No.: US 2002/0139035 A1
(43) Pub. Date: Oct. 3, 2002

(54) FISHING LINE CUTTING TOOL

(76) Inventors: Rodney Leo King, Denver, CO (US); Ian Cornel Balota, Golden, CO (US); Darin James Aldrich, Westminster, CO (US)

Correspondence Address: DARIN JAMES ALDRICH, 1130 WEST 127th CT., WESTMINSTER, CO, 80234, US

(21) Appl. No.: 09/818,471

(22) Filed: Mar. 28, 2001

(51) Int. Cl. A01K 97/00

(52) U.S. Cl. 43/17.2

(57) ABSTRACT

A tubular fishing tool to aid in the cutting of fishing line is disclosed. The fishing tool comprises a tubular frame with material selectively removed to form a pivot point for closing the tube, upper and lower cutting blades, and a plurality of holes to minimize weight and provide a method for hanging the tool onto a fishing vest. Both the tubular material and cutting blades are a corrosion-resistant material. The additional benefit of this design is the replaceable design of the blades.

### CROSS REFERENCE TO RELATED APPLICATIONS

Not applicable.

### FIELD OF THE INVENTION

The present invention involves a tool for use in fishing, more specifically to such tool that is used to cut fishing line.

### BACKGROUND OF THE INVENTION

The sport of fishing requires a wide variety of tools and accessories for assistance with different actions, such as unhooking a fish, fixing a lure to the fishing line, and tying knots. Many fisherman stand in a stream or lake while fishing which necessitates a portable tool to avoid lost time when moving out of the water to the land for tools. One of the most frequently used tools is a line cutter that is employed to clip off a section of the line when affixing a new lure or removing a tangled section of line.

Originally, the primary line-cutting tool was a fingernail clipper that was pinned to the shirt of the fisherman for convenient use. Many fisherman objected to these tools since they were not made of a corrosion-resistant material thus were prone to corrosion due to constant exposure to fresh water or salt water. The corrosion of the clipper caused the cutting blade to dull, thereby damaging the blade and rendering the clippers unable to cut fishing line.

A second problem with the traditional fingernail clipper for use in cutting fishing line was the highly reflective chrome-plated finish on the clipper. This bright finish was objectionable to many people during fishing since it reflected the sun brightly in the user's eyes.

A final problem with the traditional fingernail clippers was the lever action required to complete a cut. Many fisherman found the lever action uncomfortable to use since it a required wide gap between the thumb and forefinger when initiating the cut.

Thereafter, companies designed and produced clipping tools more specific to fishing that aimed to eliminate several of the previously discussed problems. For example, several companies produced a clipper with a matte finish to eliminate problems with reflections from the bright sun. Similarly, other companies produced clippers made of a stainless steel in an effort to minimize the corrosion problems with traditional clippers. Finally, fishing companies eliminated the lever action of the fingernail clipper, instead designing a clipper comprised of two pieces of flat metal bonded at one end, with a gap between the cutting blades at the other end. These clippers relied on the spring action of the two opposing pieces of metal.

Although the newer flat clippers are easy to use and inexpensive to manufacture, they still suffer from problems with corrosion and the dulling of the cutting blades. Since the blades are integrated directly into the flat metal clipper, they must be disposed of when they become dull.

Many companies have attempted to overcome these problems, but they have only made minor cosmetic changes to the flat clipper. Furthermore, the flat clippers have a smooth surface where the fingers are placed during use, thereby creating difficulties when they are wet.

Several types of novel fishing tools have been proposed. For example, in U.S. Pat. No. 5,136,744 (1992), Allsop and Paulic have invented a multi-purpose fishing tool to assist in line-cutting and a number of different actions. Although the tool is well-designed with a high number of functions, the tool integrates a great number of parts, thereby increasing the possibility of failure during use. In addition, the large number of parts requires expensive manufacturing and assembly. Furthermore, the tool cuts line with a sharp blade against a flat surface, which is inherently less efficient than a sharp blade against a sharp blade.

Simpson, in U.S. Pat. No. 5,850,649, has invented a fishing tool that is useful for clearing the fishing lure of debris that accumulates during fishing. Similarly, U.S. Pat. Nos. 5,557,874 and 5,568,698 disclose tools with a similar function to Simpson's tool. Neither of these tools demonstrates a cutting mechanism that improves on the previously discussed problems.

Couper, in U.S. Design Pat. No. 366,925, describes a multi-purpose fishing tool which combines the functions line cutting and lure cleaning but does not improve on problems with aforementioned line cutting tools.

### SUMMARY OF THE INVENTION

With the present invention, it has been found that a tubular shaped material can be used to form the basis of a cutting tool, particularly useful in the field of fishing.

### Objects and Advantages

Accordingly, several objects and advantages of the present invention are:

(a) to provide a fishing tool comprised of a material that is highly resistant to corrosion from exposure to fresh water or salt water;

(b) to provide a fishing tool with a matte finish which does not highly reflect the sun;

(c) to provide a fishing tool that is comfortable in the hand and easily gripped when wet;

(d) to provide a fishing tool with replaceable cutting blades;

(e) to provide a fishing tool comprised of a tubular material; and

(f) to provide a fishing tool with a minimum number of parts to reduce manufacturing costs.

Still further objects and advantages will become apparent from a consideration of the ensuing description and drawings.

### BRIEF DESCRIPTION OF THE DRAWINGS

FIG. 1 is a schematic showing a perspective view of the tubular clipper.

FIG. 2 is a schematic showing the cross sectional view of the tubular clipper.

FIG. 3 is a schematic showing the back view of the tubular clipper with the replaceable blades in the unassembled state.

FIG. 4 is a schematic showing the detail of one possible attachment method of the replaceable blades in the tubular cutter.

### DETAILED DESCRIPTION OF THE PREFERRED EMBODIMENT

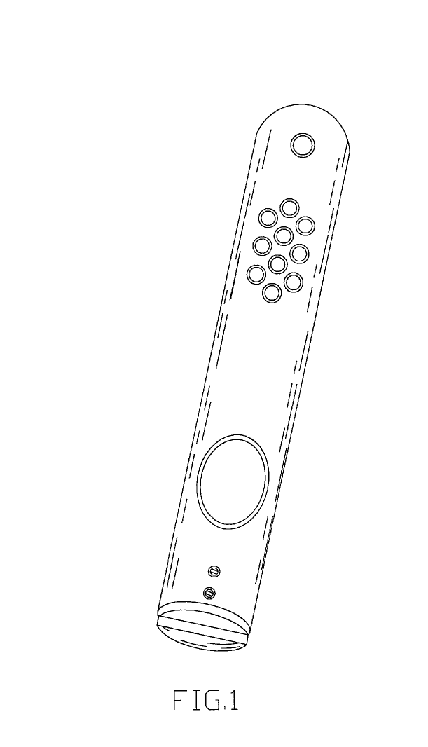

A preferred embodiment of the current invention is a tubular fishing tool that can be used to cut fishing line. FIG. 1 depicts a tubular fishing tool built in accordance with this invention.

As represented in FIG. 1, the frame of the fishing tool has a primary tubular construction formed of a unitary piece of material. The preferred material is a corrosion-resistant aerospace grade alloy of titanium, vanadium, and aluminum, such as the alloy designated Ti-3Al-2.5V. Other non-limiting examples of materials that can be used in the construction of the frame are stainless steel alloys, nickel-based alloys, or aluminum alloys. Additional tubular materials including plastics and ceramics can be similarly used for the construction of the frame.

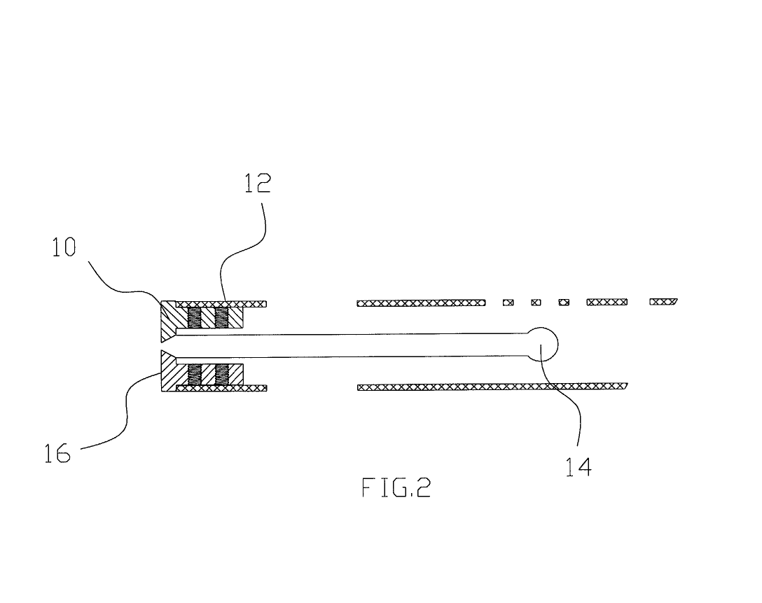

Referring now to FIG. 2, a replaceable cutting blade 10 is attached to the tubular frame 12 by any means well known by those well-versed in the art. A preferred method for attaching the cutting blade 10 to the tubular frame 12 is by a screw attachment. Some additional, non-limiting examples of attachment method are laser welding, brazing, soldering, or attaching with an adhesive material.

Referring still to FIG. 2, a general tube of material is changed into the shape of the tubular frame 12 by the selected removal of material. The material is removed in a manner along the long dimension of the tube such that the point of rotation 14 allows the upper cutting blade 10 to impinge on the lower cutting blade 16. In a preferred embodiment, the material is removed from the tube in selected locations through the use of a milling machine. Additional non-limiting examples of material removal include laser cutting, electro-discharge machining, or sawing.

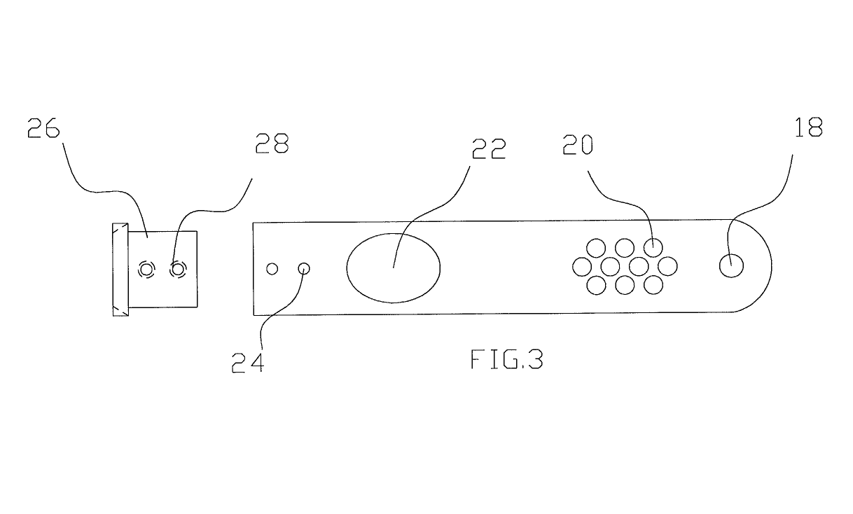

Referring now to FIG. 3, a variety of holes on the back surface of the tubular frame are shown. A mounting hole 18 is used to mount the tubular cutter to the fisherman's vest while a pattern hole 20 is used to minimize the weight of the tool. Grip point 22 is a hole removed from the tool frame to form a grip point for the fisherman's fingers. Attachment hole 24 is used as a connection point to fasten the tubular tool frame to the cutting blade 26 through attachment points 28.

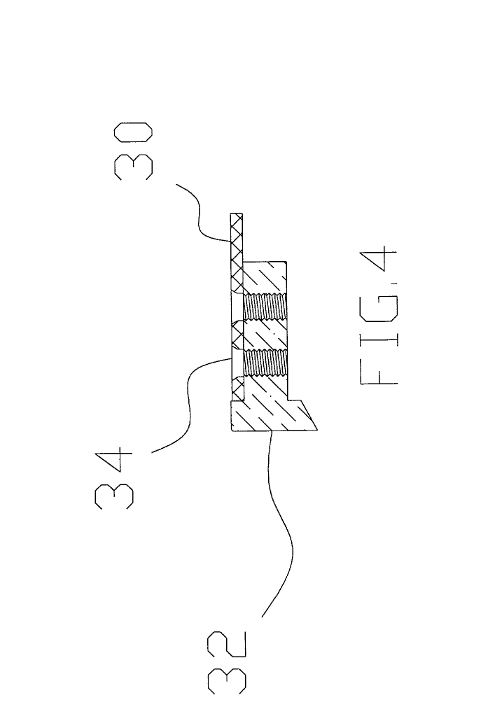

FIG. 4 shows a close-up view of the preferred attachment method between the tubular frame 30 and the upper jaw of the cutting blade 32 through the use of threaded screws 34.

What is claimed is:

1. A fishing tool comprising:
a tube with a circular cross-section, said tube including regions wherein a portion of the material has been removed to form a pivot point, additional regions wherein a portion of the material has been removed to form gripping points, said gripping points included on opposing surfaces of the tube;
two blades fixedly attached to the upper and lower half of the tube, said blades attached to the inner diameter of the tube wherein said blades are oriented towards each other when said grip points are squeezed together.

2. The method of claim 1, wherein the tube is a unitary piece of material with said blades attached to the tube in a secondary assembly operation.

3. The product of claims 1-2, wherein the tube comprises any metallic alloy, preferably a titanium alloy.

4. The product of claims 1-2, wherein the blades comprise any metallic alloy, preferably stainless steel.

5. The product of claims 1-2, wherein the tube comprises any plastic material.

6. The product of claims 1-2, wherein the tube comprises any ceramic material.

7. The product of claims 1-2, wherein the blades comprise any ceramic material.
